(19) United States
(12) Patent Application Publication
(10) Pub. No.: US 2005/0012662 A1
(43) Pub. Date: Jan. 20, 2005

(54) Dual-mode position-locating device

(75) Inventor: Yu-Feng Lin, Taipei (TW)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: Fortuna Electronic Corp., Taipei City (TW)

(21) Appl. No.: 10/859,285

(22) Filed: Jun. 1, 2004

(30) Foreign Application Priority Data
Jul. 18, 2003 (TW) 092213146

(51) Int. Cl. G01S 5/14

(52) U.S. Cl. 342/357.06

(57) ABSTRACT

A dual-mode position-locating device for receiving signals from a communication satellite to locate a user, includes a Global Positioning System (GPS) processor; a first data storage region for storing a control program accessible to the GPS processor to allow the GPS processor to analyze and process the received signals; a second data storage region controlled by the control program and for storing a high-sensitivity operational program that precisely locates the user; a third data storage region controlled by the control program and for storing a normal-sensitivity operational program that roughly locates the user; and an input unit electrically connected to the GPS processor and controlled by the control program, allowing the user to input a switching signal to the input unit so as to switch the GPS processor to execute either the high-sensitivity operational program or the normal-sensitivity operational program to perform operations for the received signals.

### FIELD OF THE INVENTION

The present invention relates to dual-mode position-locating devices, and more particularly, to a dual-mode position-locating device having both a normal-sensitivity operational program and a high-sensitivity operational program.

### BACKGROUND OF THE INVENTION

One of the biggest problems faced by drivers is how to reach their destinations in the shortest time without getting lost or unnecessarily detoured. Due to the rapid development of electronics and communication technology, Global Positioning System (GPS) technology can reduce the chances of drivers getting lost or detoured.

Besides automobile navigation, GPS technology is also applied to portable computing devices (such as vehicle-mounted computers, notebooks, and personal digital assistants (PDAs) etc.), wireless hand-held devices (such as mobile phones, pagers, personal positioning devices, etc.), and consumer products (such as watches and navigation positioning devices). The locations of users can be determined using satellite signals in conjunction with built-in mapping software of the small-scale and portable devices and products. Therefore, these small-scale and portable devices and products provide a navigation function for the users to find the shortest route between their current locations and the destinations, effectively preventing the users from getting lost or detoured.

However, the above devices and products having positioning and navigation functions are all pre-stored with a operational program that performs positioning calculations of the received GPS signals, wherein the operational speed of the operational program depends on the operating performance of the GPS processor and complexity of the operational program.

The operational program for positioning calculations usually comprises a high-sensitivity operational program and a normal-sensitivity operational program. For the normal-sensitivity operational program, the program is relatively simpler and its operational speed is relatively faster. However, when the users are walking in a signal-obstructed area such as under an overpass or viaduct or on a porch, or in an alley, the simple normal-sensitivity operational program is not made to enhance operations for diffusion and refraction of the GPS signals, and thus the quality of receiving signals is degraded.

On the contrary, the high-sensitivity operational program is enhanced and adapted to perform operations for diffusion and refraction of the GPS signals, such that it can perform good operations for position determination for the users even when they are walking in a signal obstructed area or inside a building. However, such a high-sensitivity operational program used for the diffusion and refraction of GPS signals is rather complex. As a result, a screen of the positioning and navigation device or product using the high-sensitivity operational program would operates slowly to display the position of the user since the GPS processor performs positioning calculations at a slower rate using the complex high-sensitivity operational program, thereby producing a positioning-delay phenomenon. Accordingly, when the high-sensitivity operational program is employed in a vehicle-mounted GPS device, with the vehicle moving at a high speed, the position of the vehicle located by the GPS device and displayed on the screen would significantly lag behind the actual location of the vehicle. On the contrary, the normal-sensitivity operational program does not cause this positioning-delay phenomenon.

In other words, under a condition of a high moving speed and good quality of receiving signals, a GPS positioning device with the normal-sensitivity operational program is suitably used. Contrarily, under a condition of a low moving speed and poor quality of receiving signals, a GPS positioning device with the high-sensitivity operational program is preferable.

Unfortunately, the conventional device or product with GPS functionality can only be stored with either one of the normal-sensitivity operational program or the high-sensitivity operational program in a memory thereof since the GPS processor is designed to read only a single set of parameters from the memory. Otherwise, in case both the normal-sensitivity and high-sensitivity operational programs are stored in the memory of the device or product, there would be a conflict for the GPS processor to read the parameters thereby resulting in a crash of the GPS processor.

Therefore, the problem to be solved here is to provide a position-locating device having both normal-sensitivity and high-sensitivity operational programs for performing operations for GPS signals to allow a use to obtain accurate and immediate positioning information.

### SUMMARY OF THE INVENTION

In light of the drawbacks in the prior arts, a primary objective of the present invention is to provide a dual-mode position-locating device having both normal-sensitivity and high-sensitivity operational programs for receiving and performing operations for GPS (Global Positioning System) signals.

Another objective of the present invention is to provide a dual-mode position-locating device that is adapted to use either a normal-sensitivity operational program or a high-sensitivity operational program for receiving and performing operation of GPS signals according to a user's request.

To achieve the above and other objectives, the present invention proposes a dual-mode position-locating device for receiving signals from GPS satellites so as to allow a user to determine the current location thereof. The dual-mode position-locating device comprises: a GPS processor; a first data storage region for storing a control program that is accessible to the GPS processor to allow the GPS processor to analyze and process the received signals from the communication satellite; a second data storage region controlled by the control program and for storing a high-sensitivity operational program that precisely locates the user and is executed by the GPS processor according to the corresponding received signals from the communication satellite; a third data storage region controlled by the control program and for storing a normal-sensitivity operational program that roughly locates the user and is executed by the GPS processor according to the corresponding received signals from the communication satellite; and an input unit electrically connected to the GPS processor and controlled by the control program, allowing the user to input a switching signal to the input unit so as to switch the GPS processor to execute either the high-sensitivity operational program or the normal-sensitivity operational program to perform operations for the received signals from communication satellite.

The control program, the high-sensitivity operational program and the normal-sensitivity operational program can all be stored in a memory. A reset program for resetting operational parameters is provided at a starting section of each of the high-sensitivity and normal-sensitivity operational programs. The control program is stored with address data for the high-sensitivity operational program stored in the memory and address data for the normal-sensitivity operational program stored in the memory. Thereby when the user inputs the switching signal to the input unit, the GPS processor can obtained the address data of either the high-sensitivity operational program or the normal-sensitivity operational program according to the data stored in the control program so as to access the operational program stored at the obtained storage address from the memory, such that the GPS processor executes the reset program for the operational program to reset the required operation parameters so as to avoid failure due to an operating conflict.

In another embodiment, the high-sensitivity operational program and the normal-sensitivity operational program are stored respectively in different memories or storage regions (i.e. the second and third data storage regions). The dual-mode position-locating device further comprises a switching unit electrically connected to and controlled by the GPS processor, wherein the switching unit is electrically connected to either the second data storage region for storing the high-sensitivity operational program or the third data storage region for storing the normal-sensitivity operational program. When the GPS processor receives the switching signal from the input unit, the GPS processor urges the switching unit to switch the electrical connection from one of the second and third data storage regions to the other data storage region, such that the GPS processor can access and execute the operational program stored in the data storage region electrically connected to the switching unit so as to perform operations for the received signals from the communication satellite to determine the location of the user.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing the basic structural architecture of a dual-mode position-locating device according to a first preferred embodiment of the present invention;

FIG. 2 is an operating display diagram showing the operation for switching an operational program of the dual-mode position-locating device of FIG. 1; and

FIG. 3 is a block diagram showing the basic structural architecture of a dual-mode position-locating device according to a second preferred embodiment of the present invention.

### DETAILED DESCRIPTION OF THE PREFFERED EMBODIMENT

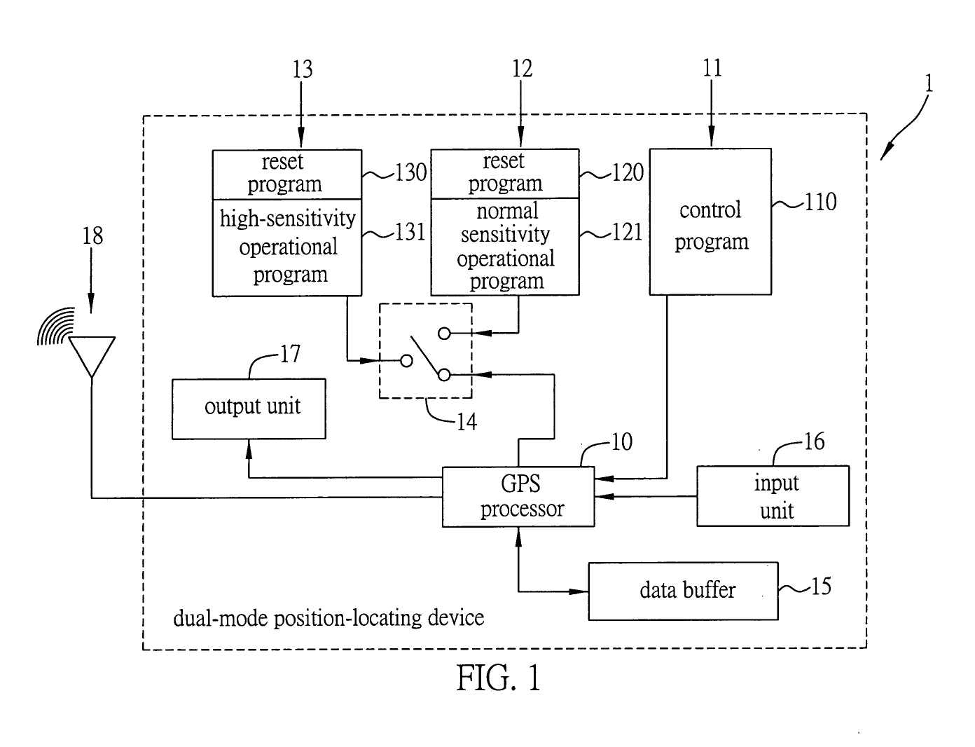

FIG. 1 shows the basic structural architecture of a dual-mode position-locating device according to a first preferred embodiment of the present invention. As shown, the dual-mode position-locating device 1 may be a portable computer device (such as vehicle-mounted computer, notebook, and PDA), wireless hand-held device (such as mobile phone, pager, and personal-positioning devices), and consumer product (such as watch and navigation-positioning device). The dual-mode position-locating device 1 comprises a GPS (Global Positioning System) processor 10, a first data storage region 11, a second data storage region 12, a third data storage region 13, a switching unit 14, a data buffer 15, an input unit 16, an output unit 17, and a receiving antenna 18.

The GPS processor 10 is a central processing unit of the dual-mode position-locating device 1 and used to analyze and process GPS signals from a communication satellite received by the receiving antenna 18. After the dual-mode position-locating device 1 is booted up, the GPS processor 10 receives the GPS signals from the receiving antenna 18 according to a control program 110 stored in the first data storage region 11, and performs analysis and processing operations. The control program 110 acts as a system program to provide the basic processes when the dual-mode position-locating device 1 is started and also provide the system setting function for a user.

The second data storage region 12 is used to store a reset program 120 and a normal-sensitivity operational program 121 that can roughly locate a position of a user. The third data storage region 13 is used to store a reset program 130 and a high-sensitivity operational program 131 that can precisely locate the position of the user. The programs stored in the second data storage region 12 and the third data storage region 13 can also be accessed by the GPS processor 10, and the access timing is controlled by the control program 110. The GPS processor 10 is electrically connected to either the second data storage region 12 or the third data storage region 13 via the switching unit 14. The control program 110 urges the switching unit 14 to perform a switching process that switches the GPS processor 10 electrically connected to one of the second and third data storage regions 12, 13 to the other data storage region. This thereby allows the GPS processor 10 to perform analysis and processing operations for the GPS signals received by the receiving antenna 18 according to the control program 110, and also allows the GPS processor 10 to read the operational program stored in the data storage region electrically connected therewith so as to determine the location of the user by the GPS signals already analyzed. Further, the GPS processor 10 can use the data buffer 15 to store the required operating parameters as references for follow-up operational processes.

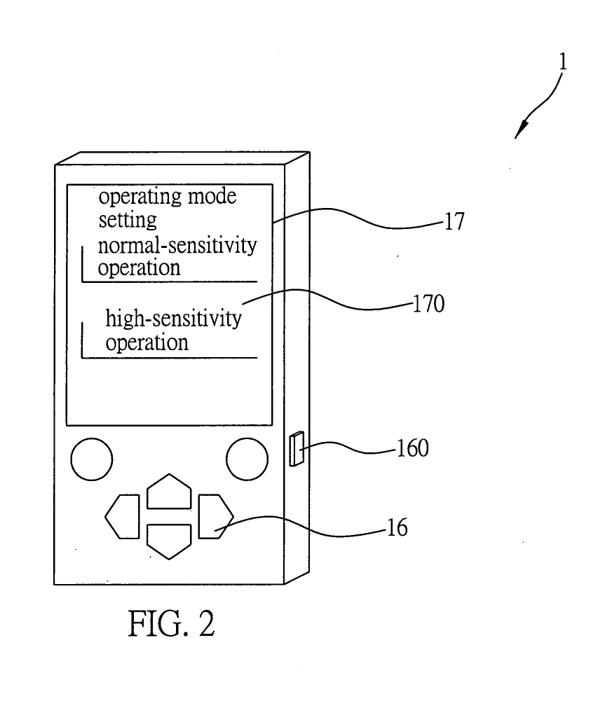

The switching process for switching the electrical connection between the GPS processor 10 and one of the second and third data storage regions 12, 13 to the other data storage region is performed by the switching unit 14 according to a signal received by the input unit 16. As shown in FIG. 2 of an operating display 170 for switching an operational program via the dual-mode position-locating device 1, the operating display 170 is provided by the control program 110, such that the user can carry out the system setting function through the control program 110. The output unit 17 (e.g. LCD, liquid crystal display) of the dual-mode position-locating device 1 shows the operating display 170 to allow the user to select a desired operational program using the input unit 16 (such as buttons). Subsequently, the GPS processor 10 receives a switching signal from the input unit 16 and urges the switching unit 14 to switch the electrical connection between the GPS processor 10 and one of the second and third data storage regions 12, 13 to the other data storage region. Thereby the GPS processor 10 can access the reset program and the operational program stored in the data storage region electrically connected to the GPS processor 10. When the switching process is done by the switching unit 14, the GPS processor 10 first executes the reset program to reset or erase the data or parameters stored in the data buffer 15 so as to avoid an operating conflict produced after the operating mode has been switched and the corresponding operational program is executed.

Furthermore, besides using software to input the switching request as described in FIG. 2, the user can also use the typical hardware. For example, a button 160 can be provided at one side of the casing of the dual-mode position-locating device 1. When the user presses the button 160, the GPS processor 10 receives a switching request from the user and allows the switching unit 14 to directly switch the electrical connection between the GPS processor 10 and one of the second and third data storage regions 12, 13 to the other data storage region.

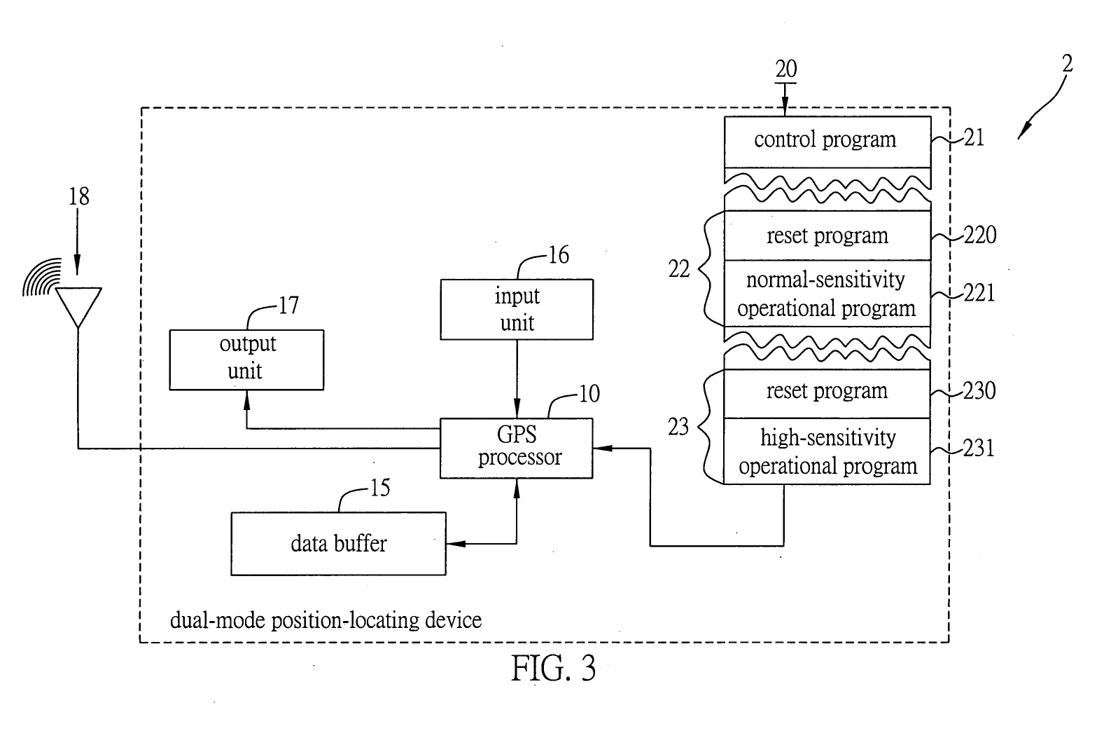

Next, referring to FIG. 3 showing the basic structural architecture of a dual-mode position-locating device according to a second preferred embodiment of the present invention, this dual-mode position-locating device 2 has substantially the same component connections and data transmission relationship as the above first embodiment, which are thus not to be further repeated, except for a memory 20. As shown in FIG. 3, in this embodiment, the memory 20 is used for storing a control program 21, a normal-sensitivity operational program 221 and a high-sensitivity operational program 231. The normal-sensitivity operational program 221 and the high-sensitivity operational program 231 are respectively provided with a reset program 220, 230 at a starting section thereof. Since all these programs are stored in the same memory 20, for the GPS processor 10 to recognize the normal-sensitivity operational program 221 and the high-sensitivity operational program 231 stored in the memory 20, the memory 20 is pre-stored with address data of blocks 22, 23 of the memory 20 for storing the normal-sensitivity operational program 221 and the high-sensitivity operational program 231 respectively and is also pre-stored with starting addresses in the blocks 22, 23 for the normal-sensitivity and high-sensitivity operational programs 221, 231. As a result, when the user inputs a switching request via the input unit 16, the GPS processor 10 can use the control program 21 to access the operational program from the memory 20 corresponding to the operating mode desired for the user and according to the pre-stored starting address for this operational program so as to execute the operational program.

In this embodiment, since the normal-sensitivity operational program 221 and the high-sensitivity operational program 231 are stored in the same memory 20, and the control program 21 is pre-stored with the address data of the blocks 22, 23 of the memory 20 for storing the operational programs 221, 231 and the starting addresses in the blocks 22, 23, therefore the switching unit 14 used in the first embodiment is not required here, and the switching process of the operating mode can be achieved simply by means of the software.

In conclusion, the dual-mode positioning device in the present invention provides users with a position-locating operation that can utilize either a normal-sensitivity operational program or a high-sensitivity operational program, such that position-locating requests made by the users under different circumstances can all be satisfied.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A dual-mode position-locating device for receive signals from a communication satellite to locate a position of a user, the dual-mode position-locating device comprising:
a Global Positioning System (GPS) processor;
a first data storage region for storing a control program that is accessible to the GPS processor to allow the GPS processor to analyze and process the received signals from the communication satellite;
a second data storage region controlled by the control program and for storing a high-sensitivity operational program that precisely locates the user and is executed by the GPS processor according to the corresponding received signals from the communication satellite;
a third data storage region controlled by the control program and for storing a normal-sensitivity operational program that roughly locates the user and is executed by the GPS processor according to the corresponding received signals from the communication satellite; and
an input unit electrically connected to the GPS processor and controlled by the control program, allowing the user to input a switching signal to the input unit so as to switch the GPS processor to execute either the high-sensitivity operational program or the normal-sensitivity operational program to perform operations for the received signals from communication satellite.

2. The dual-mode position-locating device of claim 1, further comprising a switching unit electrically connected to and controlled by the GPS processor, wherein the switching unit is electrically connected to either the second data storage region or the third data storage region, such that when the GPS processor receives the switching signal from the input unit, the GPS processor urges the switching unit to switch the electrical connection from one of the second and third data storage regions to the other data storage region so as to allow the GPS processor to access and execute the operational program stored in the data storage region that is electrically connected to the GPS processor via the switching unit.

3. The dual-mode position-locating device of claim 2, wherein a reset program is respectively stored in the second data storage region and the third data storage region to allow the GPS processor to reset operational parameters.

4. The dual-mode position-locating device of claim 1, wherein the first data storage region, the second data storage region and the third data storage region are included in a memory, and the control program is provided with a starting address for the high-sensitivity operational program in the second data storage region and a starting address for the normal-sensitivity operational program in the third data storage region, such that the GPS processor is allowed to access the high-sensitivity operational program or the normal-sensitivity operational program according to the starting addresses stored in the control program so as to execute the operational program.

5. The dual-mode position-locating device of claim 4, wherein a reset program is pre-stored at the starting address for the high-sensitivity operational program in the second data storage region to allow the GPS processor to reset operational parameters.

6. The dual-mode position-locating device of claim 4, wherein a reset program is pre-stored at the starting address for the normal-sensitivity operational program in the third data storage region to allow the GPS processor to reset operational parameters.

7. The dual-mode position-locating device of claim 1, wherein the dual-mode position-locating device is one selected from the group consisting of hand-held computer, personal digital assistant (PDA), mobile phone, and GPS hand-held device.
